(19) United States
(12) Patent Application Publication
(10) Pub. No.: US 2014/0149562 A1
(43) Pub. Date: May 29, 2014

(54) METHOD AND SYSTEM FOR PROVIDING USER-BASED BANDWIDTH MANAGEMENT

(71) Applicants: Hong XIAO, Acton, MA (US); Dongchen WANG, Concord, MA (US); Fang ZHU, Redmond, WA (US); Andre R. TURNER, Belmont, WA (US); Azim NASIR, Foxboro, MA (US)

(72) Inventors: Hong XIAO, Acton, MA (US); Dongchen WANG, Concord, MA (US); Fang ZHU, Redmond, WA (US); Andre R. TURNER, Belmont, WA (US); Azim NASIR, Foxboro, MA (US)

(73) Assignee: Verizon Patent and Licensing Inc., Basking Ridge, NJ (US)

(21) Appl. No.: 13/688,882

(22) Filed: Nov. 29, 2012

(51) Int. Cl. G06F 15/177

(52) U.S. Cl. CPC G06F 15/177
USPC 709/222

(57) ABSTRACT

An approach for enabling a user to adapt the usage of content by an application is described. An adaptation platform determines usage of content by an application satisfies a predetermined bandwidth threshold. The adaptation platform then initiates an adaptation of the usage of the content by the application based on the bandwidth configuration setting.

### BACKGROUND INFORMATION

Service providers are continually challenged to deliver value and convenience to consumers by providing compelling network services and advancing the underlying technologies. One area of interest has been the development of services and technologies for enhancing the content viewing experience of device users. Many third party content providers provide applications and services for enabling users to access and execute content, such as video on demand, from their user devices. However, the overall amount of content capable of being consumed via these applications is limited by the amount of bandwidth allocated to the user by the provider of the network, e.g., per a subscriber agreement. Unfortunately, users have no control or influence over the behavior of the application and/or bandwidth allocation.

Based on the foregoing, there is a need for enabling a user to adapt the usage of content by an application.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for enabling a user to adapt the usage of content by an application, according to one embodiment;

FIG. 2 is a diagram depicting the components of an adaptation platform, according to one embodiment;

FIGS. 3A-3E are flowcharts of processes for enabling a user to adapt the usage of content by an application, according to various embodiments;

FIGS. 4A-4C are diagrams of a user interface depicting user interaction with the adaptation platform, according to various embodiments;

FIG. 5 is a diagram of a computer system that can be used to implement various exemplary embodiments; and

FIG. 6 is a diagram of a chip set that can be used to implement an embodiment of the invention.

### DESCRIPTION OF THE PREFERRED EMBODIMENT

An apparatus, method and software for providing user-based bandwidth management are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to video or streaming content, it is contemplated these embodiments have applicability to content and media of various types. This may include, for example, audio, live or on-demand streaming media, multimedia content, web objects (e.g., text, graphics, scripts), downloadable objects (e.g., media files, software, documents), applications (e.g., e-commerce, portals), social networks and the like for on-demand execution. As will be discussed more fully herein, the content may be generated and/or provided by one or more third party content providers for use in connection with a content delivery scheme, subscription based media platform or the like.

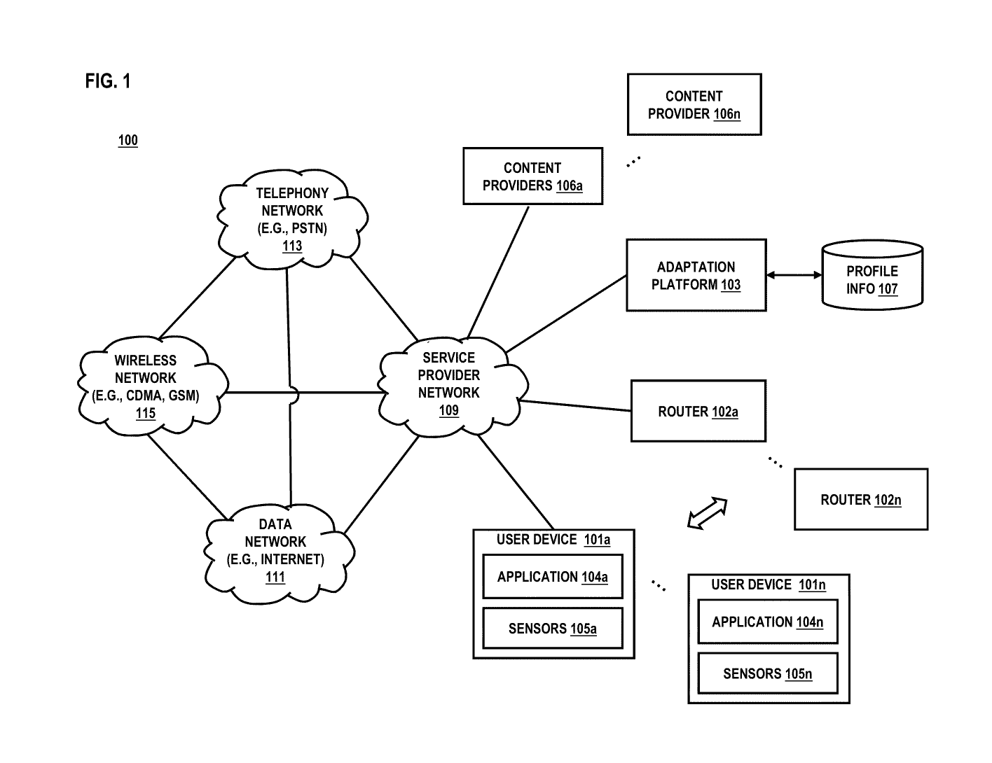

FIG. 1 is a diagram of a system for enabling a user to adapt the usage of content by an application, according to one embodiment. By way of example, the content 106a-106n may include that which is provisioned to a user device 101a-101n upon request by one or more third party content providers. The content providers 106a-106n may offer the content to users as part of a service offering for selection/execution as via an online library or catalogue. As such, the featured content may be streamed, downloaded or executed on demand by user devices 101a-101n by way of an media application 104a-104n, such as a media player, music player or movie viewer. The application 104a-104n may be provided directly by the content provider 106a-106n or may be a standard media application of the user device 101a-101n.

As mentioned previously, the usage of content by a media application is dependent upon the amount of bandwidth allocated to the user's account by the provider of a network to which they are subscribed. For example, the user may be subscribed with a wireless communication provider per a specific wireless phone and communications data plan that limits data access to a set amount per month (e.g., 5 Gigabits (GB) per month). Alternatively, the user may be subscribed with the provider to receive broadband wireless communication or video on demand services for use with their home based computers, personal entertainment devices (e.g., set-top boxes) and the like. Under this scenario, the amount of content is associated with a data capacity rate, wherein the user may even be warned by the service provider they are close to exceeding this capacity. If the limit is reached, however, the customer may experience a disabling of their content access capabilities, a significant reduction in data usage rates or even additional charges and service fees (e.g., as included in the next billing cycle). Unfortunately, users have no convenient means of adapting the usage of content, including the rate or amount of consumption of content by applications of the device while also enabling continual access to the content.

To address these issues, system 100 of FIG. 1 introduces an adaptation platform 103 that interacts with user devices 101a-101n, referred to herein as user devices 101, for enabling direct user management and adaptation of content usage. For the purpose of illustration, content consumption or usage pertains to the rate (as measured in bits per second) or amount (as measured in total bytes) of data requested by and subsequently executed by a media application 104a-104n (referred to herein collectively as applications 104) or service of the user device 101. Also, usage of content may pertain to the data conveyed to a broadband home router 102a-102n (referred to herein collectively as routers 102) or other network component that broadcasts/delivers data to the user device 101. The former content usage scenario may pertain to mobile device execution, wherein data is directly conferred to the user device 101 (e.g., via a packet data network gateway). The latter scenario pertains to an area network configuration, wherein one or more devices are configured to the network 109 via a common access point (e.g., home or office based local area network). In either case, the adaptation platform 103 provides a user of a device the ability to manipulate the characteristics of content as conveyed for prolonging the amount of content or rate of delivery of the content.

In certain embodiments, the adaptation platform 103 may be implemented as a hosted solution or service 101. According to this implementation, the adaptation platform 103 is accessed by the user device 101 via an application programming interface (API) call, via a browser application or as a widget capable of execution via an operating system (OS) of the user device 101. In addition, the adaptation platform 103 may be implemented in accordance with a cloud-based architecture, wherein various executions of the platform 103 or data sets derived by the platform 103 are subject to backend processing. Alternatively, the adaptation platform 103 may be directly integrated as a module, component or software executable capable of execution at the user device 101. Under this approach, the adaptation platform 103 may generate direct signal inputs for directly interacting and controlling various features of the user device 101 of a media application the requests content. It is noted that the foregoing embodiments contemplate either implementation or combinations thereof.

In one embodiment, the adaptation platform 103 supports the metering of content consumed by the applications 104, devices 101 and routers 102 associated with the user. Metering may pertain to any means of monitoring, tracking and/or quantifying a level or amount of bandwidth or data usage. For example, in the case of a router 102 to which multiple devices are configured, a metering result may indicate the amount of data, the rate at which data is being received and/or the percentage bandwidth consumed by each device. As another example, a particular application 104 of a user device 101 may perform metering of content it retrieves from respective content providers 106, thus returning a metering result for indicating the usage of the data.

Content metering may be performed by respective applications 104 or devices 101 via known metering applications or modules. For example, the applications 104 or devices 101 (including routers 102) may be configured with application programming interfaces (APIs) for enabling the exchange of bandwidth usage information with the adaptation platform 103. The results returned by the metering applications or modules may be derived based on the monitoring and aggregation of packet and/or protocol level statistics, such as session start and stop information, byte/packet transport information, traffic characteristic data and the like. It is noted in certain instances that the adaptation platform 103 may provide the metering application or modules as a downloadable agent for use in connection with an application, device or router during a registration/subscription procedure. Alternatively, the metering capabilities may be implemented in advance, such that API calls may be executed for supporting the exchange of metering results with the platform 103.

In another embodiment, the adaptation platform 103 determines usage of content (e.g., an amount or rate of content consumed) by one or more applications 102 and/or devices 101 associated with a user satisfies (e.g., exceeding or meeting) a predetermined threshold. In addition, the platform 103 determines whether a router 102 to which a device is configured consumes (or relays) content up to the determined threshold. Exceeding or meeting of the threshold may be determined based on persistent analysis of the metering results as returned to the adaptation platform 103. The adaptation platform 103 utilizes the threshold result as a trigger mechanism for enabling adapting of the means or mode of content consumption, and hence bandwidth or data capacity, of the corresponding application 104, user device(s) 101 or routers 102.

By way of example, the threshold may represent a percentage of the usage of content, including a percentage of the rate or amount of data consumed. Hence, in the case where the allotted data capacity for a user is, e.g., 10 GB with a predetermined threshold of, e.g., 80%, the bandwidth configuration settings may be invoked in response to usage/consumption of 8 GB of data. The threshold may be established by the provider of the network 109 as a default value, such as in accordance with a monthly subscriber agreement. Alternatively, when the user establishes a profile 107 with the adaptation platform 103, the threshold may be specified; thus enabling subscribed user devices 101 direct control over the criteria for triggering the automated adapting of bandwidth configuration settings. Under this scenario, the adaptation platform 103 may be provided in connection with the provider of the network 109 such that the user defined threshold settings may be executed. This enables a default setting as established by the service provider to be overridden in place of the value set by the user.

It is noted that the adaptation platform 103, per this model, may communicate with a backend system of the service provider or store any user defined threshold settings to a cloud data store that is accessible to the service provider network 109. Similarly, bandwidth configuration settings and context conditions, as discussed further later on herein, may also be transmitted via the platform 103 to the appropriate backend or cloud data store. Also of note, the profile information 107 maintained by subscribed users of the adaptation platform 103 may be the same as that maintained by the provider of the network 109. Hence, the adaptation platform 103 supports the merging or referencing of predefined profile information 107 for a user in accordance with a data sharing or registration agreement. Per this approach, any user defined settings, including threshold values and bandwidth configuration settings, may be referenced to or merged with any existing or newly established profile information pertaining to the user of devices 101, applications 104 and routers 102.

In one embodiment, the adaptation platform 103 enables a user to specify one or more bandwidth configuration settings for affecting the rate at which content is consumed. As noted above, the bandwidth configuration settings may be triggered in response to a determined bandwidth allocation or data capacity threshold being satisfied (per the metering results). Bandwidth configuration settings, as associated with profile information 107 for the user, are activated to affect operation of the user device, media applications 104 of the device, other user devices configured to a common network element (e.g., router 102) or with respect to the router 102 directly. The bandwidth configuration settings may include one or more parameters or values pertaining to the inflow/outflow of content to the device 101, including for example, a bit rate setting as measured in bits per second. In particular, the bit rate may be set to a lower or variable value to lessen the rate of delivery of content. Another bandwidth configuration setting may include a traffic shaping setting, wherein the user is able to delay the transfer of packets by their router device 102. By way of this approach, a router 102 serving as an access point for one or more user devices 101 may limit the rate of conveyance of data as received from a content provider 106 per a request by a media application 104. Bandwidth configuration settings may include a quality or service (QoS) identifier or content type classification (e.g., video, email), a traffic prioritization value, an overflow or buffer value, a self-limiting source level, etc.

Another bandwidth configuration setting may include a disabling and/or enabling of a video streaming feature of an application 104. Per this setting, the user may opt to restrict execution or receipt of streaming media while allowing non-streaming media (which is typically less data intensive). Still further, another bandwidth configuration setting capable of being established by the user may include the disabling and/or enabling of specific applications. Per this approach, the user may specify which applications to allow for execution in the event of threshold being met or exceeded such that more taxing applications and functions are limited during this period.

In addition, the application bandwidth configuration settings may enable the user to specify which applications are to be subject to particular bandwidth configuration settings—thus supporting customization of certain bandwidth configuration settings at the application level. By way of example, the user may opt to restrict video streaming for a media player application while allowing video streaming for a video conferencing application. As another example, a variable or lower bit rate setting may be established for all video execution applications of the user device 101 except a movie player application of the device.

In another embodiment, the adaptation platform 103 enables a user to specify one or more context conditions to associate with a given bandwidth configuration setting. The context conditions may include parameters for defining the context under which a particular bandwidth configuration setting is to be executed. By way of example, a broadband type context condition may specify a type of network 109 connectivity to be associated with a given user device 101. A wireless type may specify the device 101 accesses a network 109 via a wireless interface without local area networking (LAN) means while a wireless fidelity (WiFi) type may specify connectivity via a local area network or access point (e.g., router 102). As another example, the context condition may indicate a number of other devices associated with the user and corresponding device types (e.g., tablet, smartphone, set-top box).

In another example, the context condition may specify a location setting, such as a geo-location or a particular premise. Per this setting, the user may select a geo-location such as office, home, vacation home, business travel or friends house, etc. Alternatively, the location may be deduced by way of identification of a specific user device at a particular geo-location—i.e., a set-top box corresponding to a living room of a premise. As another example, a context condition of a time range or a date range may be set to specify periods of restriction or enablement of a particular bandwidth configuration setting. Still further, an identifier value associated with the various devices 101 of the user may be specified for enabling application of a particular bandwidth configuration setting on a device-by-device basis. This may be employed in instances where multiple devices are configured to a common router 102 that belong to different users within the same premise. Hence, in this case, each of the individual devices 101 may be configured via a profile 107, which may be an individual profile or a group profile that enables group usage and administration settings to be applied.

In certain embodiments, the above described bandwidth configuration settings and associated context conditions may be configured by a user of the device 101 subscribed to the adaptation platform 103. Also of note, the user may specify one or more of the above described settings by way of a configuration interface rendered to a display of a device 101. The configuration interface may present various selection options, including checkboxes, selection menus or the like for enabling user selection of a particular bandwidth configuration setting. In addition, the configuration interface may present options for enabling user establishment of context conditions. Of note, the user may establish these settings and conditions during an initial subscription/registration period with the adaptation platform 103, which in turn is associated with a user profile 107.

Also, in certain embodiments, that the adaptation platform 103 may recommend a particular bandwidth configuration setting to a user. For example, when the user is establishing their settings via the configuration interface of the platform 103, a message, icon, alert or other notification of the recommended setting may be rendered to the display. The recommendation may be provided based on the settings and conditions established by the user. In addition, various additional factors may be accounted for, including known or historical bandwidth usage rates of a device 101, other devices, an application 101 or a router 102. Still further, various network latency conditions or peak usage factors may also be considered. Thus, the platform 103 may employ various techniques and data types/conditions for determining an optimal recommended bandwidth configuration setting.

Once the bandwidth configuration settings and context conditions are established, the adaptation platform 103 is able to respond to any determined threshold events and/or contextual occurrences. For example, in one embodiment, the adaptation platform 103 processes context information as captured by sensors 105a-105n of respective user devices 101. This context information is processed by the platform 103 on the basis of the established context conditions as described; thus enabling the platform 103 to determine whether one or more of the context conditions have been met in conjunction with a bandwidth configuration setting.

By way of example, the sensors 105a-105n, referred to herein collectively as sensors 105, may capture context information such as location information, orientation information, temporal information or activity information pertaining to a user of the user device 101 in question. In addition, the sensors 105 may capture network information, such as internet protocol (IP) address information, application usage information and other data for enabling the platform 103 to determine if a particular context condition has been met. The context information may be collected by the adaptation platform 103 periodically, such as in accordance with a periodicity/schedule established by the user per their profile 107. Alternatively, the context information may be gathered concurrent with the gathering of metering results information.

In another embodiment, when a bandwidth threshold is triggered with respect to a media application 104, the device 101 or a network component (e.g., router 102) as described, the adaptation platform 103 references the profile information 107 accordingly. In the case where the user has not defined their specific bandwidth configuration settings but is registered to interact with the platform 103, the platform 103 renders various bandwidth configuration setting options to the user (e.g., lower bit rate) via the display of their device 101. Any option chosen by the user is then saved and stored as the default bandwidth configuration setting for the user. In addition, the selected setting is applied for affecting the bandwidth usage at the device or by the application. The lag time for adjusting the bandwidth usage from the moment of selection or activation of a particular bandwidth configuration setting may vary from one device, application or network component configuration to the next.

In the case where the user has defined their bandwidth configuration settings, the prior established bandwidth configuration settings (and associated context conditions) may be automatically invoked by the adaptation platform 103 for addressing subsequent threshold events and/or contextual occurrences. Hence, the adaptation platform 103 enables any registered device 101 or group thereof, application 102 or group thereof, or network components or group thereof associated with a common user to be readily configured to adapt the rate or amount of bandwidth usage. The following paragraphs present various use case scenarios corresponding to execution of the platform 103.

In one use case scenario, a user (Julie) has a limited wireless data plan (e.g., 5 GB per month) as per her subscription agreement with her mobile carrier. She often uses her mobile phone to watch movies via a video on demand application and services. Having configured her device for interaction with the adaptation platform 103, when her data plan reaches to 70%, the platform 103 prompts here to select a bandwidth bandwidth configuration setting. Julie selects the option to lower the bit rate from A bits/second to B bits/second or by X percentage. Once she saves this option, she is able to continue watching her movies or videos, albeit with lower quality, without concern for the data limit. Also, in this case, having saved the setting as a default, the next time the threshold limit is breached, the platform 103 will automatically execute the bandwidth configuration setting.

In another use case scenario, a user (Tammy) is subscribed with a service provider that offers a home entertainment and wireless services data plan that is limited to 20 GB per month. As such, Tammy is subscribed with the provider to receive premium television content via different devices in her home, including a set-top box, along with high speed internet at service. When the data usage reaches 85%, the adaptation platform 103 as configured to or accessed by her set-top box generates a prompt via her television (TV) for her to make an adjustment to lower her video quality from A bits/second to B bits/second or by X percentage. In addition, Tammy can is also able to define various additional bandwidth configuration settings and contextual conditions pertaining to other devices within her home directly from the television interface.

In another use case scenario, a user (Larry) has a limited wireless data plan (5 GB per month) as per his subscription agreement with his mobile carrier. Having configured his bandwidth threshold previously to 80 percent as well as selected various bandwidth configuration settings, he is able to manage is data usage. Hence, his settings enable him to automatically disable video streaming with respect to his cell phone when the limit is met or exceeded while enabling only email and global positioning system related applications. In addition, his settings enable automatic disabling of video streaming using wireless data while enabling video streaming using WiFi (via his router 102) when he is at home (based on location information). Still further, Larry's settings calls for the enabling/disabling of select other apps and services based.

In yet another use case scenario, a user (Jack) has several devices, including his set-top box and various computing devices, configured to a service provider network via a broadband home router (BHR). Some of the other computing devices belong to others within his household, who are also authorized by Jack to access the network accordingly. By way of the metering execution of the adaptation platform 103, Jack is able to view metering results for all of the devices and hence their current bandwidth usage (e.g., as a percentage of overall allocation) via his television. He notices his son is currently playing a video game, which is consuming a significant amount of bandwidth. In addition, he wants to watch a football game, which will further consume bandwidth. Rather than forgo the game or require his son to quit his video game play, Jack is able to divide the bandwidth among the different devices configured to the network router per the established settings. In addition, notices that certain devices are consuming bandwidth but are not presently in use and opts to disable those devices—thus enabling more allocation of the limited bandwidth for him and his son. Still further, as the profile administrator, Jack can also restrict bandwidth on his son's PC during weekdays so that his son will not be able to play video games, while still having access to the internet for completing homework assignments.

It is noted therefore that the bandwidth configuration settings and associated context conditions enable a broad means of user customization of device, application or network component (router) behavior in response to a determined threshold event. For example, while the bandwidth configuration settings may define how the bandwidth or data capacity is to be adjusted and managed accordingly, the context conditions enable dynamic application of said rules. Hence, in the case where a bandwidth configuration setting of a variable interest rate is set to be applied in response to the threshold being met or exceeded, a context condition may limit this execution to a specific date range or time period only. As another example, a traffic shaping policy to be triggered for execution with respect to a router 102 may be enforced for only select devices or users within the network of a given premise.

In certain embodiments, user devices 101, the adaptation platform 103 and other elements of system 100 may be configured to communicate via a service provider network 109. According to certain embodiments, one or more networks, such as data network 111, telephony network 113 and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions. The adaptation platform 103 may be further interfaced with external networks, including those of third party content providers, by way of various network interface and sharing arrangements and policies.

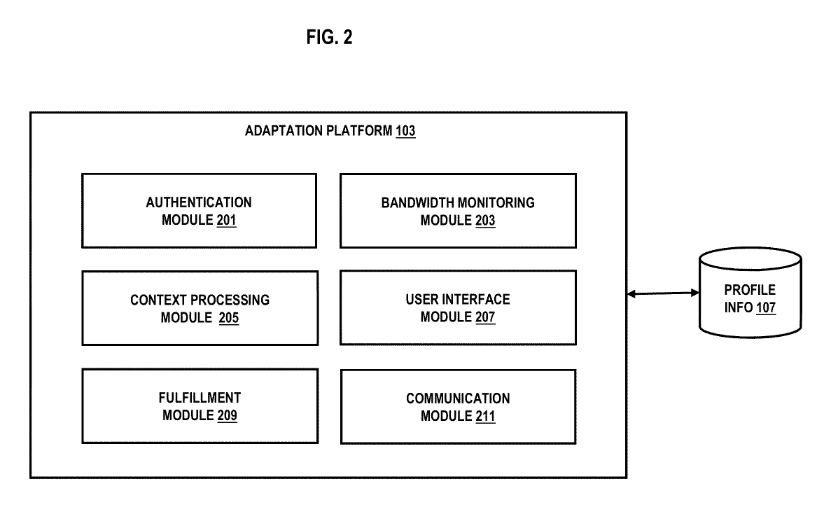

FIG. 2 is a diagram of an adaptation platform, according to one embodiment. The adaptation platform 103 includes various executable modules for performing one or more computing, data processing and network based instructions that in combination provide a means of providing user-based bandwidth management. Such modules can be implemented in hardware, firmware, software or a combination thereof. By way of example, the adaptation platform103 may include an authentication module 201, a bandwidth monitoring module 203, a context processing module 205, a user interface module 207, a fulfillment module 209 and a communication module 211.

In one embodiment, an authentication module 201 authenticates users and user devices 101a-101n as well as routers 102a-102n for interaction with the platform 103. By way of example, the authentication module 201 receives a request to subscribe to the platform 103 for enabling configuration of bandwidth configuration settings. In addition, the user may association one or more context conditions with the bandwidth configuration settings. The subscription process may include the establishment of various bandwidth configuration settings and associated conditions on a per device or per application basis as well as the setting of a preferred bandwidth usage threshold. Preferences and settings information may be referenced to a specific user, user device, or combination thereof, and maintained as profile data 107 or associated with existing profile data for the user. The authentication module 201 may operate in connection with the user interface module 207 for supporting the generation of a configuration interface for receiving user input.

The authentication process performed by the module 201 may also include receiving and validating a login name and/or user identification value as provided or established for a particular user during a subscription or registration process. The login name and/or user identification value may be received as input provided by the user from the user device 101 or other device via a graphical user interface to the platform 103 (e.g., as enabled by user interface module 207). Profile information 107 for respective subscribers, which contains pertinent user or device profile data, may be cross referenced as part of the login process. Alternatively, the login process may be performed through automated association of profile information 107 with an IP address, a carrier detection signal of a user device, mobile directory number (MDN), subscriber identity module (SIM) (e.g., of a SIM card), radio frequency identifier (RFID) tag or other identifier.

In one embodiment, the bandwidth monitoring module 203 retrieves monitoring results information from the various configured devices 101 and applications periodically. In addition, the module 203 generates a signal for indicating that a threshold limit has been reached or exceeded by the user relative to the amount of content being consumed via their device or application. The module 203 then triggers execution of the communication module 211, which sends a notification message to the device for alerting the user. The notification may include a message for prompting the user to select an adaptation setting option (e.g., reduced bit rate) based on the threshold. Alternatively, the message may indicate to the user that a prior setting has been applied automatically, which corresponds to execution of the fulfillment module 209 for carrying out the adapting.

In another embodiment, the context processing module 205 processes context information as received from the various sensors 105a-105n to determine whether a context condition has been met relative to a bandwidth configuration setting. By way of example, the context information may be collected by the adaptation platform 103 periodically, such as in accordance with a periodicity/schedule established by the user per their profile 107. Alternatively, the context information may be gathered concurrent with the gathering of metering results information as processed by the bandwidth monitoring module 203.

In another embodiment, the fulfillment module 209 causes the adaptation of bandwidth usage by a device, application thereof, other devices or a network component based on the established bandwidth configuration settings. In addition, the fulfillment module 209 carries out the adaptation according to the established context conditions being fulfilled as determined per the context processing module 205. By way of example, the fulfillment module 209 may generate a signal for causing a requesting application to adjust to a lower bit rate. As another example, the module 209 may generate a signal for adapting the behavior of a routing device 102, thus causing it to modify a quality of service marking, IP precedence bit, or other value of the packets corresponding to the content for affecting the priority/pace of delivery. It is noted that the fulfillment module 209 may invoke an adaptation by way of one or more application programming interfaces, which are capable of being interacted with at a device, network or application level via the communication module 211.

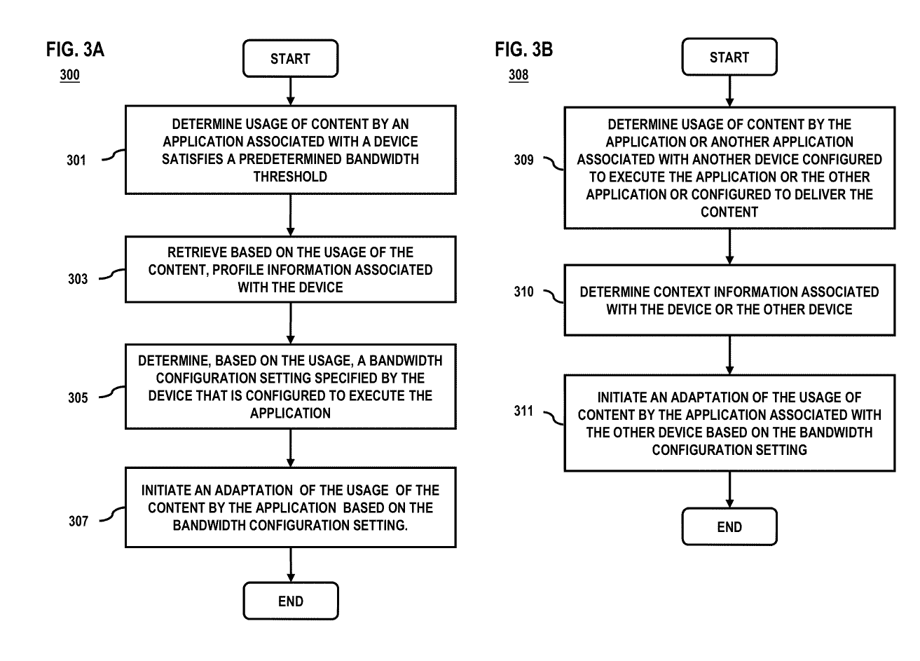

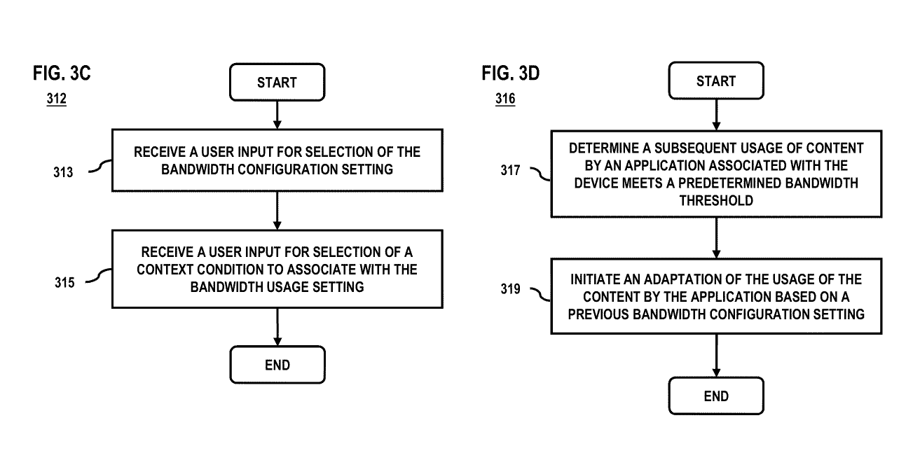

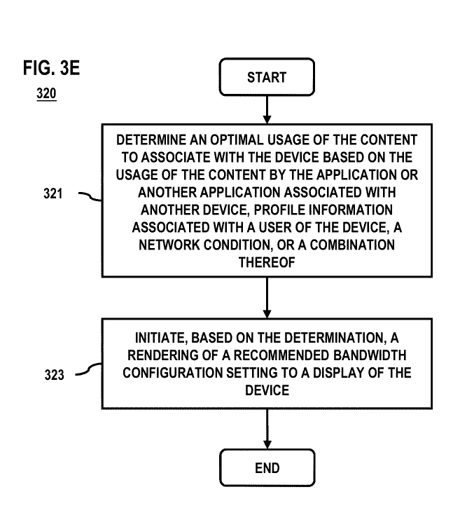

FIGS. 3A-3E are flowcharts of processes for enabling a user to adapt the usage of content by an application, according to various embodiments. For the purpose of illustration, the processes are described with respect to FIG. 1. It is noted that the steps of the processes may be performed in any suitable order, as well as combined or separated in any suitable manner.

In step 301 of process 300, the adaptation platform 103 determines usage of content by an application associated with a device satisfies a predetermined bandwidth threshold. As noted previously, this is based on the metering results data as collected persistently by the application. In another step 303, the platform 103 retrieves, based on the usage of the content, profile information associated with the device. Per step 305, the platform 103 determines, based on the usage, a bandwidth configuration setting specified by the device that is configured to execute the application. This corresponds to retrieval of the profile information 107, wherein the bandwidth configuration settings and context conditions set by the user are referenced accordingly.

In another step 307, the adaptation platform 103 initiates an adaptation of the usage of the content by the application based on the bandwidth configuration setting. The adaptation may also be initiated based on an amount or rate of delivery of the content by a network component associated with the device based on the bandwidth configuration setting. As noted, the adaptation may be performed by way of application programming interface executions.

In step 309 of process 308 (FIG. 3B), the adaptation platform 103 determines usage of content by an application associated with another device associated with the user. In another step 310, the platform 103 determines context information associated with the device or the other device. Per step 311, the platform 103 initiates an adaptation of the usage of content by the application associated with the other device based on the bandwidth configuration setting. As noted previously, the device or the other device may be a broadband router or a mobile device associated with a user of the device that is configured to execute the application. Also of note, the adaptation of the usage of the content by the application is based on the usage of content by the application (e.g., the same application at the other device) or the other application associated with the other device. In addition, the adaptation may be based on the context information (e.g., based on a satisfying of one or more context conditions).

Per step 313 of process 312 (FIG. 3C), the adaptation platform 103 receives a user input for selection of the bandwidth configuration setting. As noted previously, the bandwidth configuration setting may include a lower bit rate, a traffic shaping setting, a disabling and/or enabling of a video streaming feature of the device or the application, a disabling and/or enabling of another application, or a combination thereof. In another step 315, the adaptation platform 103 receives a user input for selection of a context condition to associate with the bandwidth configuration setting. As mentioned before, the context condition may include a broadband type, a number of other devices associated with the user, a device type, a location, a time range, an identifier value associated with the device or the number of other devices, or a combination thereof.

In step 317 of process 316 (FIG. 3D), the adaptation platform 103 determines a subsequent usage of content by an application associated with the device meets the predetermined bandwidth threshold. Per step 319, the platform 103 initiates an adaptation of the usage of the content by the application based on a previous bandwidth configuration setting. It is noted that this corresponds to the scenario wherein the prior bandwidth configuration setting, as well as any associated context condition, are stored per the profile 107 as a default setting for automatic invocation.

In step 321 of process 320 (FIG. 3E), the adaptation platform 103 determines an optimal usage of the content to associate with the device based on the usage of the content by the application or another application associated with another device, profile information associated with a user of the device, a network condition, or a combination thereof. Also, in step 323, the platform 103 initiates, based on the determination, a rendering of a recommended bandwidth configuration setting to a display of the device of the user.

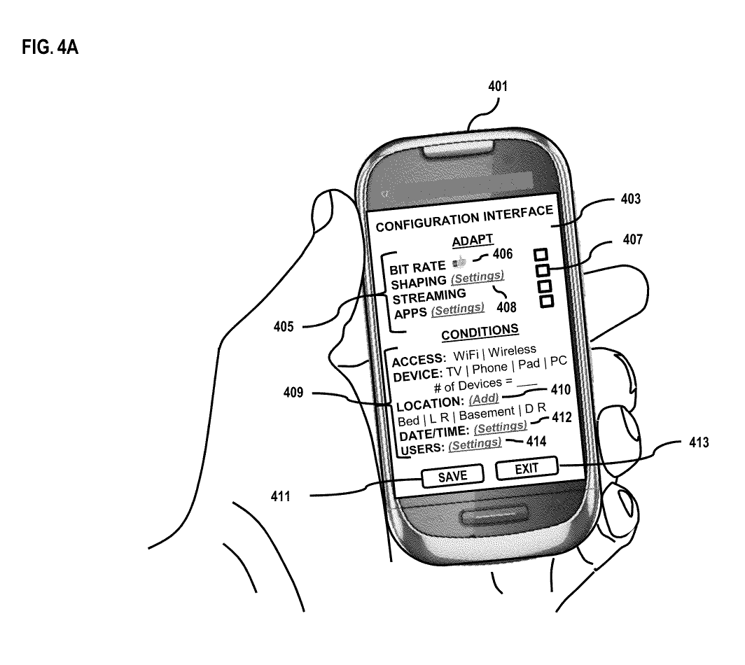

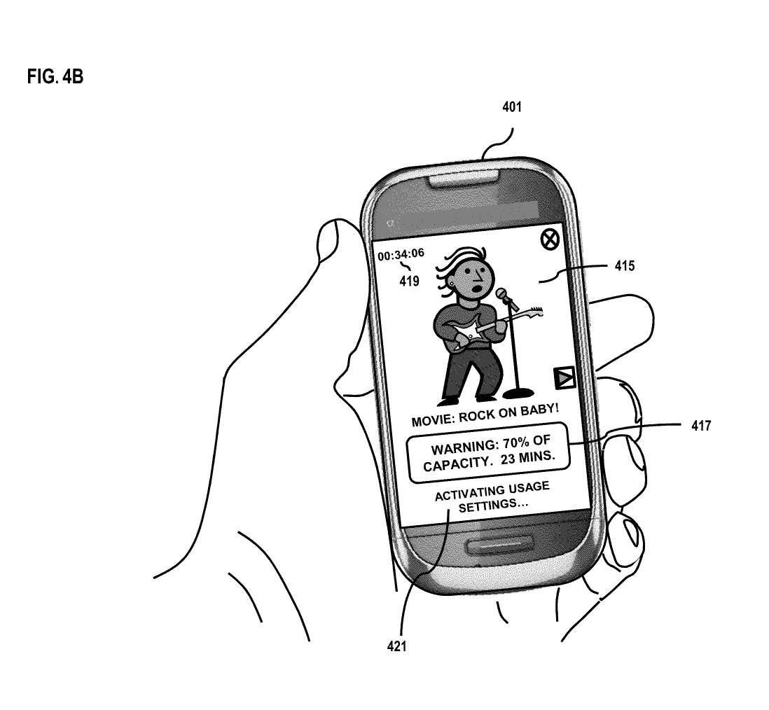

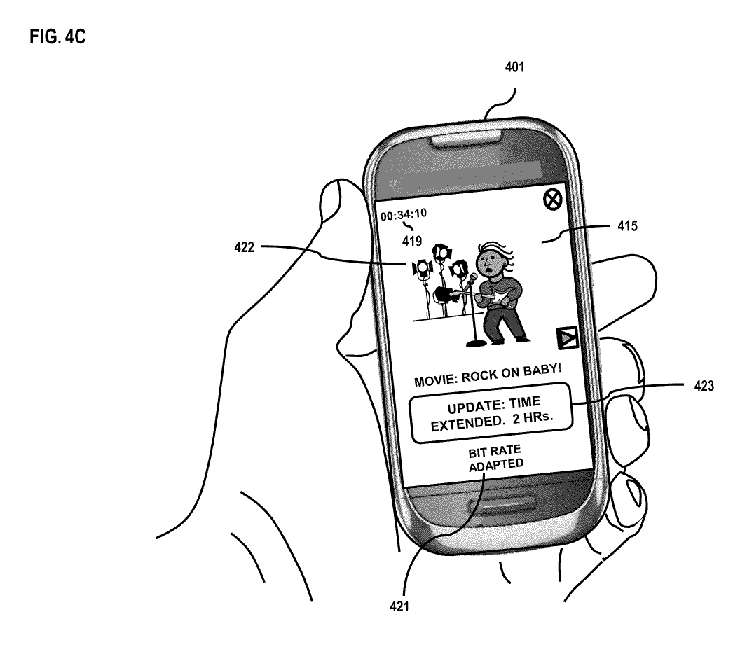

FIGS. 4A-4C are diagrams of a user interface depicting user interaction with the adaptation platform, according to various embodiments. By way of example, FIG. 4A corresponds to a configuration interface for enabling a user to establish their bandwidth configuration settings and context conditions relative to a wireless mobility context. For the purpose of illustration, this diagram corresponds to a first time configuration of the setting, wherein the settings established via this interface become the default settings. FIGS. 4B and 4C depict automated execution of the settings once established. It is noted that the configuration interface 415 may also be accessed by way of a registration and/or subscription procedure with the adaptation platform 103 or during a subscription process with the network service provider.

In FIG. 4A, the configuration interface 403 presents various user selection options for enabling the user to define how the device 401 and/or a media application is to respond to a satisfying of the bandwidth threshold limit. The selection options include multiple adaptation options 405 for enabling the user to select, via checkbox (e.g., checkbox 407), one or more bandwidth configuration settings. The adaptation options 405 include a bit rate activation option for enabling the bit rate to be varied or lowered. An icon 406 is also presented along with the bit rate selection option for indicating this option is a recommended bandwidth configuration setting per the adaptation platform 103. Alternatively, the recommendation may be presented as a notification message or the like. In certain embodiments, the recommended bandwidth configuration setting may be presented based on various factors regarding the user, the device 401, network conditions associated with the network service provider, known context information or the like.

Also, a traffic shaping option is presented for enabling activation of traffic limiting or management factors. A “Settings” link 408 may also be selected with respect to this option for enabling a user to customize how content traffic or packets are shaped, including establishing of an overflow condition, traffic class designations, traffic boundaries (e.g., self-limiting source), etc. In addition, the user may define a specific delay period for transmission of packets. It is noted that the shaping option, while shown herein, is relevant to a premise based network context, wherein the configuration of a router device or other network component associated with the user is required.

Still further, a streaming option may be selected by the user for enabling the disabling and/or enabling of streaming video. In addition, specific applications may be selected for enablement and/or disablement via another “Settings” link. As such, the user may reference which applications are to be allowed to be executed or not in response to a bandwidth threshold being reached. The applications may be selected from a menu (not shown). It is noted that the adaptation options 405 may be set for an individual application or a collection of applications. In addition, applications selected may be automatically defaulted for offline execution instead of disablement at the discretion of the user.

The condition options 409 enable the user to establish various contextual conditions for affecting activation of an established adaptation option 405. In this scenario, the user may select an access condition for defining the network/mobility context associated with the device. This corresponds to an option of WiFi or Wireless for indicating a particular broadband context corresponding to the network environment of the device 401. A device context is also presented for enabling the user to select the device type corresponding to the settings 405 as a television (TV), phone, tablet (pad), personal computer (PC), etc. In addition, the user may specify a number of devices configured to the same network (e.g., BHR). Still further, the user may specify a location condition for indicating a geo-location of a device or the presence of the device at a given premise. For example, a “Bed” location setting may be selected based on the detection of a device configured within a bedroom of the premise. While not shown, other locations may include “John's House” or “Office,” which corresponds to geo-locations of the user. It is noted that additional locations may be specified, including additional rooms or locations outside the premise, by activating the “Add” link 410.

The user may also activate date and time conditions by way of another “Settings” link 412. By way of example, the user may set restrictions upon the accessing of content corresponding to a particular date or time range. In addition, the user may further establish settings for restricting content, such as movie content, that extends beyond a certain duration of time (e.g., restrict movies beyond with a duration beyond 1.5 hours). Still further, the user may specify a particular user condition by way of another “Settings” link 414, such as for indicating particular users of to restrict from receiving content. Again, the conditional settings may be applied with respect to multiple applications or individual applications or services.

Once the user has established their settings, the user can select the SAVE action button 411 to store these settings along with the user profile information. This also enables the settings to become the default settings for subsequent use in response to a metering threshold event. Alternatively, the user may select the EXIT action button 413 to cancel any of the established settings and exit the configuration interface 403. In the case of a cancelation, prior established default settings are employed by the platform for initiation and carrying out adaptations.

In FIG. 4B, having established the bandwidth configuration settings and associated context conditions, the platform 103 initiates a rendering of a warning message 417 to the display of the device 401. The warning message 417 is issued in response to a determined 70% bandwidth threshold being reached as the user enjoys a movie. A countdown time 419 is presented for indicated that 34 minutes and 6 seconds remain for full play of the movie. However, the warning message 417 indicates that the user only has 23 minutes of available viewing time available based on the current rate of consumption of their allocated bandwidth. In this case, the adaptation platform 103 is triggered to activate a bandwidth configuration setting, as indicated to the user via status message 421.

In FIG. 4C, having adapted the bandwidth configuration setting at the device or application level accordingly, an update message 423 is presented in place of the warning message. The message 423 indicates that the amount of time remaining for viewing of content is extended to, e.g., 2 hours. In addition, the status message 421 is also updated to indicate that the bit rate bandwidth configuration setting was applied for enabling the extension of time. As such, the user is able to continue viewing the movie without having to manually interview or adapt the video execution settings of the application. It is also noted that the movie content 422 was able to continuously play even during the adaptation procedure, with a minimal delay period in this case of 4 seconds as indicated via the difference in the countdown timer. The delay period may vary depending on device implementations and network conditions.

The exemplary techniques and systems presented herein enable a user to adapt the usage of content, i.e., the rate or amount of consumption of content consumed by an application. This is achieved with limited intervention on the part of the user as prior established bandwidth configuration setting and/or context conditions may be applied in subsequent content consumption scenarios. By way of the adaptation platform 103, the device users may better manage the use of their limited bandwidth resources.

The processes described herein for enabling a user to adapt the usage of content by an application may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

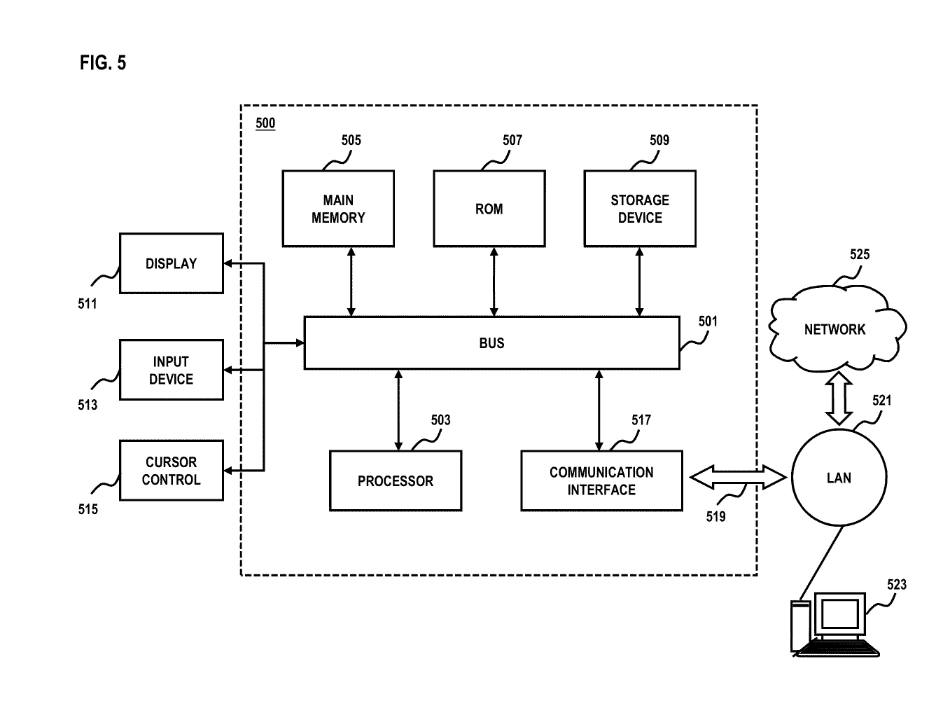

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIGS. 4A-4C, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory) —i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

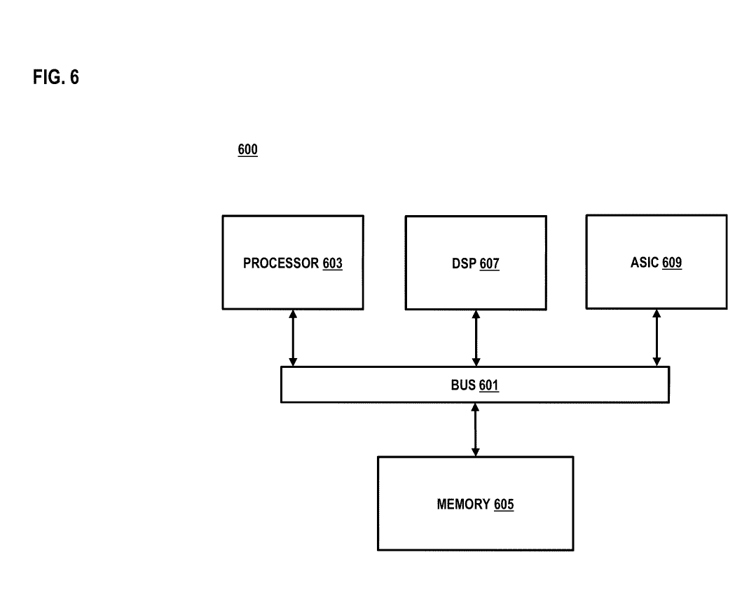

FIG. 6 illustrates a chip set or chip 600 upon which an embodiment of the invention may be implemented. Chip set 600 is programmed to enable a user to adapt the usage of content by an application as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of enabling a user to adapt the usage of content by an application.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable a user to adapt the usage of content by an application. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining usage of content by an application satisfies a predetermined bandwidth threshold;
determining, based on the usage, a bandwidth configuration setting specified by the device that is configured to execute the application; and
initiating an adaptation of the usage of the content by the application based on the bandwidth configuration setting.

2. A method of claim 1, further comprising:
determining usage of content by the application or another application associated with another device configured to execute the application or the other application or configured to deliver the content; and
initiating an adaptation of the usage of content by the application associated with the other device based on the bandwidth configuration setting.

3. A method of claim 2, further comprising:
determining context information associated with the device or the other device,
wherein adaptation of the usage of the content by the application is based on the usage of content by the application or the other application associated with the other device and/or the context information.

4. A method of claim 2, wherein the device or the other device is a broadband router or a mobile device associated with a user of the device that is configured to execute the application.

5. A method of claim 1, further comprising:
receiving a user input for selection of the bandwidth configuration setting,
wherein the bandwidth configuration setting specifies a lower bit rate, a traffic shaping setting, a disabling and/or enabling of a video streaming feature of the application, a disabling and/or enabling of another application, or a combination thereof.

6. A method of claim 1, further comprising:
receiving a user input for selection of a context condition to associate with the bandwidth configuration setting,
wherein the context condition includes a broadband type, a number of other devices associated with the user, a device type, a location, a time range, an identifier value associated with the device or the number of other devices, or a combination thereof.

7. A method of claim 1, further comprising:
determining a subsequent usage of content by an application associated with the device meets the predetermined bandwidth threshold; and
initiating an adaptation of the usage of the content by the application based on a previous bandwidth configuration setting.

8. A method of claim 1, further comprising:
determining an optimal usage of the content to associate with the device based on the usage of the content by the application or another application associated with another device, profile information associated with a user of the device, a network condition, or a combination thereof; and
initiating, based on the determination, a rendering of a recommended bandwidth configuration setting to a display of the device.

9. A method of claim 1, further comprising:
retrieving, based on the usage of the content, profile information associated with the device,
wherein the profile information includes the bandwidth configuration setting.

10. A method of claim 1, wherein the bandwidth threshold is set by the user or a provider of a service provider network associated with the device.

11. An apparatus comprising:
at least one processor; and
at least one memory including computer program code for one or more programs,
the at least one memory and the computer program code configured to, with the at least one processor, cause the apparatus to perform at least the following,
determine usage of content by an application satisfies a predetermined bandwidth threshold;
determine, based on the usage, a bandwidth configuration setting specified by the device that is configured to execute the application; and
initiate an adaptation of the usage of the content by the application based on the bandwidth configuration setting.

12. An apparatus of claim 11, wherein the apparatus is further caused to:
determine usage of content by the application or another application associated with another device configured to execute the application or the other application or configured to deliver the content; and
initiate an adaptation of the usage of content by the application associated with the other device based on the bandwidth configuration setting.

13. An apparatus of claim 12, wherein the apparatus is further caused to:
determine context information associated with the device or the other device,
wherein adaptation of the usage of the content by the application is based on the usage of content by the application or the other application associated with the other device and/or the context information.

14. An apparatus of claim 12, wherein the device or the other device is a broadband router or a mobile device associated with a user of the device that is configured to execute the application.

15. An apparatus of claim 11, wherein the apparatus is further caused to:
receive a user input for selection of the bandwidth configuration setting,
wherein the bandwidth configuration setting specifies a lower bit rate, a traffic shaping setting, a disabling and/or enabling of a video streaming feature of the application, a disabling and/or enabling of another application, or a combination thereof.

16. An apparatus of claim 11, wherein the apparatus is further caused to:
receive a user input for selection of a context condition to associate with the bandwidth configuration setting,
wherein the context condition includes a broadband type, a number of other devices associated with the user, a device type, a location, a time range, an identifier value associated with the device or the number of other devices, or a combination thereof.

17. An apparatus of claim 11, wherein the apparatus is further caused to:
determine a subsequent usage of content by an application associated with the device meets the predetermined bandwidth threshold; and
initiate an adaptation of the usage of the content by the application based on a previous bandwidth configuration setting.

18. An apparatus of claim 11, wherein the apparatus is further caused to:
determine an optimal usage of the content to associate with the device based on the usage of the content by the application or another application associated with another device, profile information associated with a user of the device, a network condition, or a combination thereof; and
initiate, based on the determination, a rendering of a recommended bandwidth configuration setting to a display of the device.

19. An apparatus of claim 11, wherein the apparatus is further caused to:
retrieve, based on the usage of the content, profile information associated with the device,
wherein the profile information includes the bandwidth configuration setting.

20. An apparatus of claim 11, wherein the bandwidth threshold is set by the user or a provider of a service provider network associated with the device.
